(19) United States
(12) Patent Application Publication
(10) Pub. No.: US 2025/0285057 A1
(43) Pub. Date: Sep. 11, 2025

(54) ELECTRONIC DEVICE AND METHOD

(71) Applicants: HYUNDAI MOTOR COMPANY, Seoul (KR); KIA CORPORATION, Seoul (KR)

(72) Inventors: Ju Hyun Noh, Hwaseong-si (KR); Jung Hwa Jung, Hwaseong-si (KR); Yun A Hyeon, Hwaseong-si (KR)

(73) Assignees: HYUNDAI MOTOR COMPANY, Seoul (KR); KIA CORPORATION, Seoul (KR)

(21) Appl. No.: 19/069,814

(22) Filed: Mar. 4, 2025

(30) Foreign Application Priority Data
Mar. 5, 2024 (KR) 10-2024-0031534
Aug. 23, 2024 (KR) 10-2024-0113727

(51) Int. Cl. G06Q 10/0633; G06Q 10/02; G06Q 20/40; G06Q 50/47

(52) U.S. Cl. CPC G06Q 10/0633; G06Q 10/02; G06Q 20/4014; G06Q 50/47

(57) ABSTRACT

An electronic device includes a memory that stores at least one instruction and includes a processor that executes the at least one instruction. The processor executes the at least one instruction to obtain at least one of information about a caller calling a vehicle including the electronic device to a departure point, information about the departure point provided by the caller, or any combination thereof. The processor also executes the at least one instruction to register card information of a card corresponding to the information about the caller when the card information is not registered corresponding to the information about the caller. The card information is obtained based on a first card tagging of the caller who boards the vehicle at the departure point.

### CROSS-REFERENCE TO RELATED APPLICATION

This application claims the benefit of and priority to Korean Patent Application No. 10-2024-0031534, filed in the Korean Intellectual Property Office on Mar. 5, 2024 and Korean Patent Application No. 10-2024-0113727, filed in the Korean Intellectual Property Office on Aug. 23, 2024, the entire contents of which are incorporated herein by reference.

### TECHNICAL FIELD

The present disclosure relates to an electronic device and a method and more particularly relates to a technique for paying a fare for boarding a called vehicle.

### BACKGROUND

Because the pace of technological development increases, digitally disadvantaged people with relatively low accessibility to digital devices and services have been excluded from technological development. Accordingly, technological improvements have been requested I to improve accessibility for the digitally disadvantaged.

Because a scheme for satisfying user demand with limited vehicles is sought, technology for calling a vehicle through an electronic device has been developed. The technology for calling a vehicle may satisfy user demand with limited vehicles by dispatching vehicles according to the user demand. However, there is a need to simplify procedures to improve accessibility for the digitally disadvantaged. The subject matter described in this background section is intended to promote an understanding of the background of the disclosure and thus may include subject matter that is not already known to those of ordinary skill in the art.

### SUMMARY

The present disclosure has been made to solve the above-mentioned problems while advantages achieved by the prior art are maintained intact.

One aspect of the present disclosure provides an electronic device and a method capable of identifying a caller who calls a vehicle.

Another aspect of the present disclosure provides an electronic device and a method capable of paying for a vehicle ride of a caller.

Still another aspect of the present disclosure provides an electronic device and a method capable of improving caller convenience.

Still another aspect of the present disclosure provides an electronic device and a method capable of improving the accessibility of vehicle calling by simplifying a card registration process.

Still another aspect of the present disclosure provides an electronic device and a method capable of improving the accessibility of vehicle calling by simplifying a caller identification process and a payment process.

Still another aspect of the present disclosure provides an electronic device and a method capable of reducing the maintenance cost of a vehicle calling service.

Still another aspect of the present disclosure provides an electronic device and a method capable of improving service accessibility for the transportation disadvantaged.

The technical problems to be solved by the present disclosure are not limited to the aforementioned problems. Any other technical problems not mentioned herein should be clearly understood from the following description by those having ordinary skill in the art to which the present disclosure pertains.

According to one aspect of the present disclosure, an electronic device includes a memory that stores at least one instruction and includes a processor that executes the at least one instruction.

According to an embodiment, the processor may execute the at least one instruction to obtain at least one of information about a caller calling a vehicle including the electronic device to a departure point, information about the departure point provided by the caller, or any combination thereof. The processor may also execute the at least one instruction to register card information of a card corresponding to the information about the caller when the card information is not registered corresponding to the information about the caller. The card information is obtained based on a first card tagging of the caller who boards the vehicle at the departure point.

According to an embodiment, the processor may execute the at least one instruction to pay for the vehicle boarding of the caller based on a second card tagging of the caller after registering the obtained card information corresponding to the information about the caller.

According to an embodiment, the processor may execute the at least one instruction to determine whether the card information obtained based on a third card tagging matches the registered card information when the card information is registered corresponding to the information about the caller. The processor may also execute the at least one instruction to pay for the vehicle boarding of the caller based on a third card tagging when the card information obtained based on the third card tagging matches the registered card information.

According to an embodiment, the processor may execute the at least one instruction to provide guidance to the caller on how to call one of a plurality of vehicles including the vehicle, by identifying that the caller gets off the vehicle.

According to an embodiment, the processor may execute the at least one instruction to provide a driver of the vehicle with at least one of the information about the caller, the information about the departure point, or any combination thereof, through an application for the driver of the vehicle. The processor may also execute the at least one instruction to provide the driver with guidance for performing the first card tagging. The processor may also execute the at least one instruction to provide the driver with guidance for determining whether to register the obtained card information corresponding to the information of the caller. The processor may also execute the at least one instruction to provide the driver with guidance for performing the second card tagging.

According to an embodiment, the processor may execute the at least one instruction to determine whether the caller is on board based on the second card tagging.

According to an embodiment, the electronic device may further include a communication circuit. The processor may execute the at least one instruction to obtain the card information by receiving the card information obtained based on the first card tagging from a card tagging device through the communication circuit.

According to an embodiment, the processor may execute the at least one instruction to identify the card information based on an identification number of the card and identify the information about the caller based on the identification number of the caller.

According to an embodiment, the processor may execute the at least one instruction to provide a driver of the vehicle with information about a caller whose card information is not registered among information about each of a plurality of callers when the plurality of callers exists.

According to an embodiment, the processor may execute the at least one instruction to provide the driver with guidance for designating information about a caller to be registered corresponding to the card information obtained based on the first card tagging among the information about each of the plurality of callers when the plurality of callers exists according to information about a caller who is not registered corresponding to the card information.

According to another aspect of the present disclosure, a method performed by an electronic device includes obtaining at least one of information about a caller calling a vehicle including the electronic device to a departure point, information about the departure point provided by the caller, or any combination thereof. The method further includes registering card information of a card corresponding to the information about the caller when the card information is not registered corresponding to the information about the caller. The card information is obtained based on a first card tagging of the caller who boards the vehicle at the departure point.

According to an embodiment, the method may further include paying for the vehicle boarding of the caller based on a second card tagging of the caller after registering the obtained card information corresponding to the information about the caller.

According to an embodiment, the method may further include determining whether the card information obtained based on a third card tagging matches the registered card information when the card information is registered corresponding to the information about the caller. The method may further include paying for the vehicle boarding of the caller based on a third card tagging when the card information obtained based on the third card tagging matches the registered card information.

According to an embodiment, the method may further include providing guidance to the caller on how to call one of a plurality of vehicles including the vehicle, by identifying that the caller gets off the vehicle.

According to an embodiment, the method may further include providing a driver of the vehicle with at least one of the information about the caller, the information about the departure point, or any combination thereof, through an application for the driver of the vehicle. The method may further include providing the driver with guidance for performing the first card tagging. The method may further include providing the driver with guidance for determining whether to register the obtained card information corresponding to the information of the caller. The method may further include providing the driver with guidance for performing the second card tagging.

According to an embodiment, the method may further include determining whether the caller is on board based on the second card tagging.

According to an embodiment, registering the card information may include obtaining the card information by receiving the card information obtained based on the first card tagging from a card tagging device through a communication circuit.

According to an embodiment, the card information may include an identification number of the card, and the information about the caller may include an identification number of the caller.

According to an embodiment, the method may further include providing a driver of the vehicle with information about a caller whose card information is not registered among information about each of a plurality of callers when the plurality of callers exists.

According to an embodiment, the method may further include providing the driver with guidance for designating information about a caller to be registered corresponding to the card information obtained based on the first card tagging among the information about each of the plurality of callers when the plurality of callers exists according to information about a caller who is not registered corresponding to the card information.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating the configuration of an electronic device according to an embodiment of the present disclosure;

FIG. 2 is a block diagram illustrating the configuration of a vehicle calling system according to an embodiment of the present disclosure;

FIG. 3 is a diagram illustrating an example of guidance for determining whether to register obtained card information corresponding to caller information in an electronic device and a method according to an embodiment of the present disclosure;

FIG. 4 is a diagram illustrating an example of guidance indicating a passenger state in an electronic device and a method according to an embodiment of the present disclosure;

FIG. 5 is a flowchart illustrating an example of an operation of paying for a vehicle ride in an electronic device and a method according to an embodiment of the present disclosure;

FIG. 6 is a flowchart illustrating an example of an operation of registering card information in an electronic device and a method according to an embodiment of the present disclosure; and

FIG. 7 is a block diagram illustrating a computing system related to an electronic device and a method according to an embodiment of the present disclosure.

### DETAILED DESCRIPTION

Various embodiments of the present disclosure may be described with reference to accompanying drawings. Accordingly, those having ordinary skill in the art should recognize that modification, equivalent, and/or alternative on the various embodiments described herein may be variously made without departing from the scope and spirit of the present disclosure.

Hereinafter, some embodiments of the present disclosure are described in detail with reference to the drawings. In adding the reference numerals to the components of each drawing, it should be noted that the identical or equivalent components are denoted by the identical numeral even if the components are displayed on other drawings. Further, in describing the embodiment of the present disclosure, a detailed description of the related known configuration or function has been omitted when it is determined that the description interferes with the understanding of the embodiments of the present disclosure.

In addition, terms, such as first, second, A, B, (a), (b) or the like, may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those having ordinary skill in the art to which the present disclosure pertains. The terms defined in the generally used dictionaries should be construed as having the meanings that coincide with the meanings of the contexts of the related technologies. The terms should not be construed as ideal or excessively formal meanings unless clearly defined in the specification of the present disclosure.

In addition, in the present disclosure, expressions of ‘more than’ or ‘less than’ may be used to determine whether a specific condition is satisfied or fulfilled. However, this is only a description for expressing an example and does not exclude expressions of ‘more than or equal to’ or ‘less than or equal to’. Conditions written as ‘more than or equal to’ may be replaced with ‘exceeding’, conditions written as ‘less than or equal to’ may be replaced with ‘less than’, and conditions written as ‘more than or equal to and less than’ may be replaced with ‘exceeding and less than or equal to’. Further, hereinafter, ‘A’ to ‘B’ means at least one of the elements from A (including A) to B (including B).

It should be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

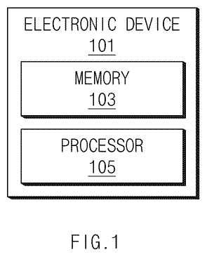

Hereinafter, examples of the present disclosure are described in detail with reference to FIGS. 1-7.

FIG. 1 is a block diagram illustrating the configuration of an electronic device according to an embodiment of the present disclosure.

Referring to FIG. 1, an electronic device 101 may include a memory 103 and a processor 105. The memory 103 may store at least one instruction. The processor 105 may execute at least one instruction stored in the memory 103.

According to an embodiment, a vehicle including the electronic device 101 may be called by a plurality of callers. For example, one of the plurality of callers may use a kiosk or a terminal of a caller to call vehicle (e.g., a bus or taxi) to transport the caller from a departure point to a destination point. However, aspects of the present disclosure may not be limited thereto.

According to an embodiment, the kiosk or the caller's terminal may provide the electronic device 101 with the identification number of the caller (e.g., the caller's telephone number) attempting to call an arbitrary vehicle included in a plurality of vehicles. The kiosk or the caller's terminal may provide the electronic device 101 with information about the departure point of the caller.

According to an embodiment, the processor 105 of the electronic device 101 included in the vehicle may obtain at least one of information among information about the caller, information about the departure point provided by the caller, or any combination thereof.

According to an embodiment, the vehicle may move to the departure point based on the obtained departure point information. According to an embodiment, when the card information (e.g., the serial number of the card) corresponding to the obtained caller information is not registered, the processor 105 of the electronic device 101 may register the card information obtained based on a first card tagging of the caller who boards the vehicle at the departure point, corresponding to the caller information. When the card information is registered to correspond to the caller information, the processor 105 of the electronic device 101 may identify the caller information only by card tagging when the caller boards the vehicle after registration. The caller information may include at least one of a portion or all of the identification number of the caller (e.g., the last four digits of the phone number), the full name of the caller, the nickname of the caller, or any combination thereof.

According to an embodiment, the processor 105 of the electronic device 101 may pay for the vehicle boarding of the caller based on a second card tagging of the caller after registering the obtained card information corresponding to the caller information. The card information may include information necessary to identify the card and information necessary to make a payment. For example, the card information may include a portion or all of the card identification number (e.g., the last digits of the card serial number).

According to an embodiment, the processor 105 of the electronic device 101 may obtain the card information based on a third card tagging performed by the caller after the caller gets into the vehicle when the caller boards the vehicle after registering the card information corresponding to the caller information. The processor 105 of the electronic device 101 may determine whether the card information obtained to determine whether the caller boards the vehicle matches the card information registered corresponding to the caller information. When the card information obtained based on the third card tagging matches the registered card information, the processor 105 of the electronic device 101 may pay for the vehicle boarding of the caller based on the third card tagging.

According to an embodiment, the processor 105 of the electronic device 101 may determine whether the caller boards the vehicle, based on the second card tagging or the third card tagging that provides the card information that matches the card information registered corresponding to the caller information.

According to an embodiment, the processor 105 of the electronic device 101 may provide guidance to the caller on how to call an arbitrary vehicle of the plurality of vehicles including the vehicle, by identifying that the caller is getting off the vehicle. For example, the processor 105 of the electronic device 101 may provide guidance to the caller terminal on how to call a vehicle to a desired departure point via at least one of a call, a kiosk, an application, or any combination thereof.

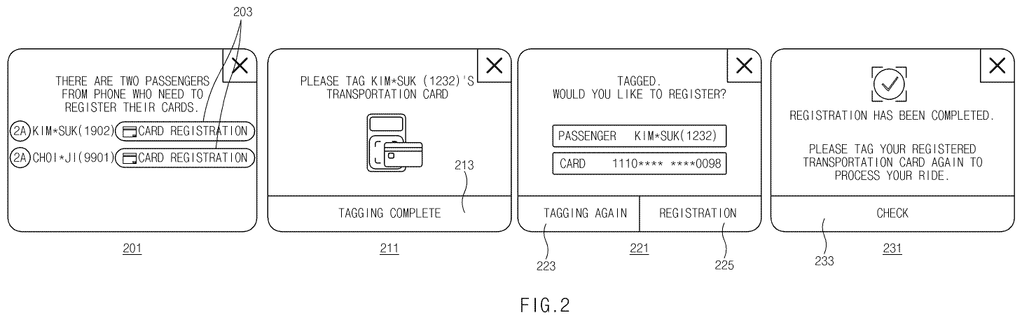

According to an embodiment, the processor 105 of the electronic device 101 may provide guidance to the driver through an application for the driver. Hereinafter, a screen including guidance provided by an application for a driver is described with reference to FIGS. 2, 3, and 4.

FIG. 2 is a block diagram illustrating the configuration of a vehicle calling system according to an embodiment of the present disclosure.

Referring to FIG. 2, when there are two or more callers, a first screen 201 may include guidance indicating the information of a caller whose card information is not registered among the caller information of each of the two or more callers. A second screen 211 may include guidance for performing the first card tagging of the caller. A third screen 221 may include guidance for determining whether to register the obtained card information corresponding to the caller information. A fourth screen 231 may include guidance for performing the second card tagging for payment.

According to an embodiment, when there are two or more callers according to the caller information, whose card information is not registered correspondingly, the processor of the electronic device may, through the first screen 201, provide the driver with guidance for specifying the caller information for registering the card information among the caller information of each of the two or more callers.

According to an embodiment, when there is at least one caller who boards the vehicle at the departure point where the vehicle is stopped among the callers who are not registered with the card information (e.g. callers who call the vehicle by phone call), the processor of the electronic device may display, through the first screen 201, at least one caller who boards from the departure point among callers whose card information is not registered correspondingly at the top of the list of callers who board from the departure point. According to an embodiment, the processor of the electronic device may provide the driver with a screen indicating whether the caller gets on or off the vehicle when the window of the first screen 201 is closed.

According to an embodiment, the processor of the electronic device may identify the caller information to register the information about the card specified through an input of the driver by a first button 203.

According to an embodiment, the processor of the electronic device may provide the driver with guidance for performing the first card tagging of the caller through the second screen 211. The driver may request the first card tagging from the caller with reference to the guidance for performing the first card tagging. The caller may tag the card on a card tagging device. According to an embodiment, the processor of the electronic device may receive the card information obtained from the card tagging device based on the first card tagging from the card tagging device through a communication circuit (e.g., a wireless communication circuit, a wired communication circuit, or the like). According to an embodiment, the communication circuit may include a Bluetooth communication circuit, but aspects of the present disclosure may not be limited thereto.

According to an embodiment, the processor of the electronic device may provide the driver with the third screen 221 when the card information is obtained according to the first card tagging even though an input of the driver by the second button 213 is not obtained.

According to an embodiment, the processor of the electronic device may determine whether the first card tagging is complete through the input of the driver by the second button 213.

For example, when the first card tagging is performed normally and the card information is obtained according to the first card tagging after obtaining the input of the driver by the second button 213, the processor of the electronic device may provide the driver with the third screen 221.

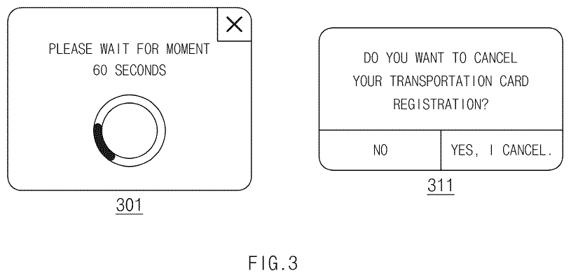

For example, when the first card tagging is not performed normally after the input of the driver by the second button 213 is obtained, and thus the card information according to the first card tagging is not obtained, the processor of the electronic device may provide the driver with the first screen 301 of FIG. 3.

According to an embodiment, the processor of the electronic device may provide the first screen 201 to the driver when the window of the second screen 211 is closed.

According to an embodiment, the processor of the electronic device may provide, through the third screen 221, the driver with guidance for determining whether to register the card information obtained based on the first card tagging corresponding to the caller information.

According to an embodiment, the driver may choose whether to register the obtained card information corresponding to the caller information, based on whether a portion or all of the name of the cardholder included in the card information matches the portion or all of the name of the caller included in the caller information.

According to an embodiment, the processor of the electronic device may provide the driver again with guidance for performing the first card tagging included in the second screen 211 through the input of the driver by a third button 223.

According to an embodiment, the processor of the electronic device may register the card information obtained through the first card tagging corresponding to the caller information through the input of the driver by a fourth button 225.

According to an embodiment, the processor of the electronic device may provide a second screen 311 of FIG. 3 to the driver when the window of the third screen 221 is closed.

According to an embodiment, the processor of the electronic device may provide the driver with guidance for performing the second card tagging for payment through the fourth screen 231. The driver may request the second card tagging from the caller with reference the guidance for performing the second card tagging. The caller may tag the card on the card tagging device. According to an embodiment, the processor of the electronic device may pay for the vehicle boarding of the caller based on the second card tagging. According to an embodiment, the processor of the electronic device may determine whether the second card tagging is completed through the input of the driver by a fifth button 233.

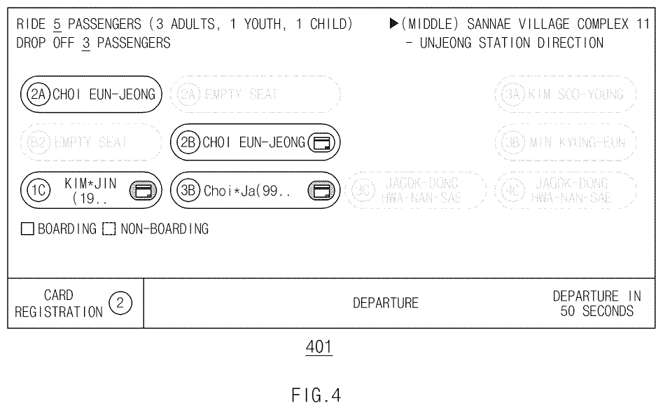

According to an embodiment, the processor of the electronic device may provide a screen 401 of FIG. 4 to the driver if the window of the fourth screen 231 is closed.

FIG. 3 is a diagram illustrating an example of guidance for determining whether to register obtained card information corresponding to caller information in an electronic device and a method according to an embodiment of the present disclosure.

Referring to FIG. 3, the first screen 301 may include guidance indicating that the card information according to the first card tagging is not obtained. The second screen 311 may include guidance for determining whether to register the card information according to the first card tagging corresponding to the caller information.

According to an embodiment, the processor of the electronic device may automatically close the window of the first screen 301 when the card information according to the first card tagging is not obtained during a specified time period. According to an embodiment, the processor of the electronic device may provide the driver with the third screen 221 of FIG. 2 including the guidance for determining whether to register the obtained card information corresponding to the caller information when the card information according to the first card tagging is obtained during the specified time period.

According to an embodiment, the processor of the electronic device may provide the driver with the second screen 211 of FIG. 2, which indicates guidance for performing the first card tagging of the caller, when the window of the first screen 301 is closed.

According to an embodiment, the processor of the electronic device may register the card information according to the first card tagging corresponding to the caller information based on the input of the driver.

FIG. 4 is a diagram illustrating an example of guidance indicating a passenger state in an electronic device and a method according to an embodiment of the present disclosure.

Referring to FIG. 4, the screen 401 may include guidance for the seat of a boarded caller or a non-boarded caller.

According to an embodiment, the screen 401 may represent at least one piece of: information among caller information that is registered corresponding to card information, caller information that is not registered corresponding to card information, information about a boarded caller, information about a non-boarded caller, or any combination thereof. when a card registration button is selected, the processor of the electronic device may provide the driver with a list of information about callers unregistered corresponding to the card information.

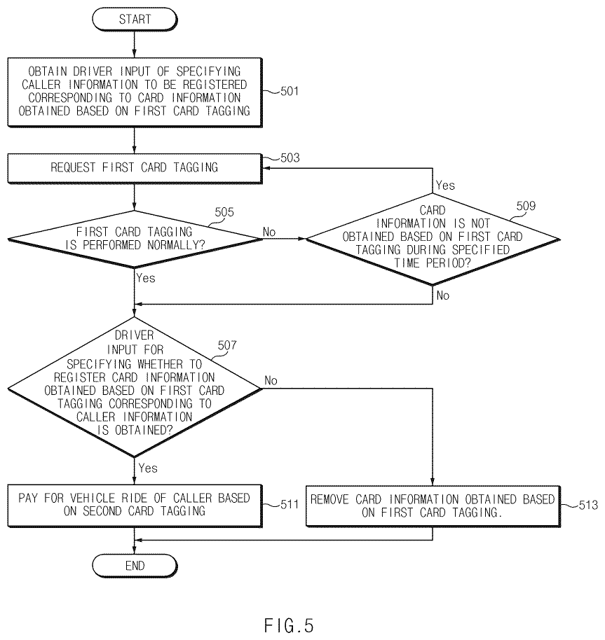

FIG. 5 is a flowchart illustrating an example of an operation of paying for a vehicle ride in an electronic device and a method according to an embodiment of the present disclosure.

Hereinafter, it is assumed that the electronic device 101 of FIG. 1 performs the process of FIG. 5. In addition, in the description of FIG. 5, the operations described as being performed by an electronic device may be understood as being performed by the processor 105 of the electronic device 101 of FIG. 1.

Referring to FIG. 5, in first operation 501, the processor of the electronic device according to an embodiment may obtain a driver input of specifying the caller information to be registered corresponding to the card information obtained based on the first card tagging.

In other words, the processor of the electronic device may obtain the input of the driver for specifying the information about a caller whose card information obtained based on the first card tagging is to be registered, among information about callers who are not registered corresponding to the card information.

In second operation 503, the processor of the electronic device according to an embodiment may request the first card tagging.

For example, the processor of the electronic device may request the first card tagging from the driver, and the driver may request the first card tagging from the caller.

As another example, the processor of the electronic device may request the first card tagging directly from the caller through a visual or auditory notification.

In third operation 505, the processor of the electronic device according to an embodiment may determine whether the first card tagging is performed normally. When the first card tagging is performed normally, the processor of the electronic device according to an embodiment may perform fourth operation 507. When the first card tagging is not performed normally, the processor of the electronic device according to an embodiment may perform fifth operation 509.

According to an embodiment, the processor of the electronic device may obtain the card information according to the first card tagging when the first card tagging is performed normally.

In fifth operation 509, the processor of the electronic device according to an embodiment may determine whether the card information is not obtained based on the first card tagging during a specified time period. When the card information is not obtained based on the first card tagging during the specified time period, the processor of the electronic device according to an embodiment may perform second operation 503. When the card information is obtained based on the first card tagging during the specified time period, the processor of the electronic device according to an embodiment may perform fourth operation 507.

In fourth operation 507, the processor of the electronic device according to an embodiment may determine whether the input of the driver for specifying whether to register the card information obtained based on the first card tagging corresponding to the caller information is obtained. When the input of the driver for specifying whether to register the card information obtained based on the first card tagging corresponding to the caller information is obtained, the processor of the electronic device according to an embodiment may perform sixth operation 511. When the input of the driver for specifying whether to register the card information obtained based on the first card tagging corresponding to the caller information is not obtained, the processor of the electronic device according to an embodiment may perform seventh operation 513.

In sixth operation 511, the processor of the electronic device according to an embodiment may pay for the vehicle ride of the caller based on the second card tagging.

In seventh operation 513, the processor of the electronic device according to an embodiment may remove the card information that is obtained based on the first card tagging and registered corresponding to the caller information.

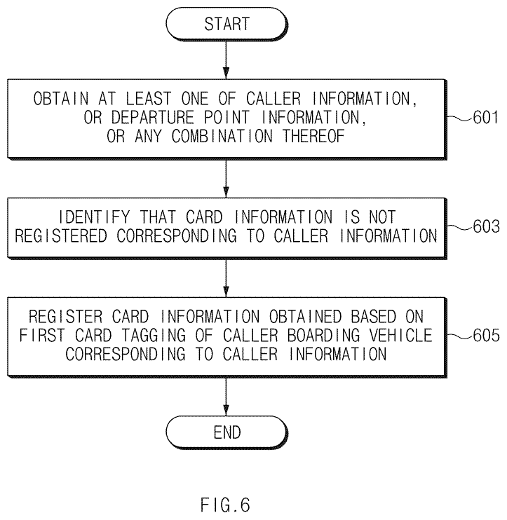

FIG. 6 is a flowchart illustrating an example of an operation of registering card information in an electronic device and a method according to an embodiment of the present disclosure.

Hereinafter, it is assumed that the electronic device 101 of FIG. 1 performs the process of FIG. 6. In addition, in the description of FIG. 6, the operations described as being performed by an electronic device may be understood as being performed by the processor 105 of the electronic device 101 of FIG. 1.

Referring to FIG. 6, in first operation 601, the processor of the electronic device according to an embodiment may obtain at least one of caller information, departure point information, or any combination thereof.

According to an embodiment, the caller may include a user who calls a vehicle including the electronic device to the departure point. The departure point information may be provided by the caller to the electronic device.

In second operation 603, the processor of the electronic device according to an embodiment may identify that the card information is not registered corresponding to the caller information.

In third operation 605, the processor of the electronic device according to an embodiment may register the card information obtained based on the first card tagging of a caller boarding the vehicle corresponding to the caller information.

According to an embodiment, the electronic device may be included in a vehicle called by the caller. The vehicle (e.g., a demand-responsive taxi, a demand-responsive bus, or the like) that includes the electronic device may be called through a kiosk or a caller terminal. The vehicle including the electronic device may change the driving route based on the call of the caller.

According to an embodiment, the driving route of the vehicle determined based on the call histories of callers may be provided to the caller through the caller terminal. The caller may determine whether the called vehicle arrives by referring to the driving route provided through the caller terminal.

An existing scheme of calling a vehicle may be difficult for the transportation-disadvantaged (e.g., the elderly) to use. According to the existing scheme of calling a vehicle, the caller may be required to personally perform a membership registration process, an identity verification process, a card registration process, and a departure and destination designation process, which is complicated, so the membership withdrawal rate of users calling a vehicle may be higher than a specified value.

In addition, according to the existing scheme of calling a vehicle, it may be difficult to confirm the departure point and departure time when the caller boards the vehicle after calling a vehicle, and a fee may be charged for not boarding.

To supplement the existing scheme of calling a vehicle, a scheme of calling a vehicle by phone through the terminal of a caller has been used. However, because a counselor must be present to maintain the service, the service maintenance cost is higher than a standard cost, and the information transmission rate is lower than the standard due to the voice transmission scheme.

The processor of the electronic device according to an embodiment may provide a more convenient vehicle calling scheme to transportation disadvantaged persons. In addition, because there is no separate membership registration or card registration process other than providing a phone number and name or performing card tagging, the scheme of calling a vehicle by the electronic device according to an embodiment may improve the user experience compared to the user experience of the existing scheme of calling a vehicle.

According to an embodiment, the processor of the electronic device may provide the driver of the vehicle with guidance for card registration of the caller through an application (e.g., a driver app) for the driver.

According to an embodiment, the processor of the electronic device may provide the driver with guidance for the first card tagging when the input of the driver for card registration is identified through an application for the driver of the vehicle.

According to an embodiment, the processor of the electronic device may register, through an application for the driver of the vehicle, the card information according to the first card tagging corresponding to the caller information when the first card tagging is performed normally.

According to an embodiment, the processor of the electronic device may provide the driver with guidance for the second card tagging through the application for the vehicle driver.

According to an embodiment, when the second card tagging is performed normally, the processor of the electronic device may pay for the vehicle boarding of the caller based on the second card tagging.

According to an embodiment, the processor of the electronic device may provide the caller with guidance for a scheme of calling an arbitrary one of the plurality of vehicles based on identifying that the caller gets off the vehicle. The guidance for a scheme of calling an arbitrary one of the plurality of vehicles may be provided to the caller when the caller needs to be moved from the drop-off location to another location.

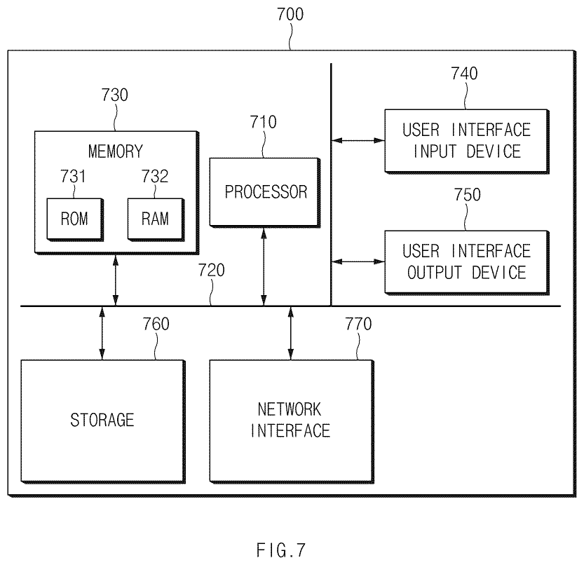

FIG. 7 is a block diagram illustrating a computing system related to an electronic device and method according to an embodiment of the present disclosure.

Referring to FIG. 7, a computing system 700 may include at least one processor 710, a memory 730, a user interface input device 740, a user interface output device 750, a storage 760, and a network interface 770 connected through a bus 720.

The processor 710 may be a central processing unit (CPU) or a semiconductor device that processes instructions stored in the memory 730 and/or the storage 760. The memory 730 and the storage 760 may include various volatile or nonvolatile storage media. For example, the memory 730 may include a read only memory (ROM) 731 and a random access memory (RAM) 732.

Accordingly, the processes of the method or algorithm described in relation to the embodiments of the present disclosure may be implemented directly by hardware executed by the processor 710, a software module, or any combination thereof. The software module may reside in a storage medium (i.e., the memory 730 and/or the storage 760), such as a RAM memory, a flash memory, a ROM memory, an EPROM memory, an EEPROM memory, a register, a hard disk, solid state drive (SSD), a detachable disk, or a CD-ROM.

The storage medium is coupled to the processor 710, and the processor 710 may read information from the storage medium and may write information in the storage medium. In another method, the storage medium may be integrated with the processor 710. The processor and the storage medium may reside in an application specific integrated circuit (ASIC). The ASIC may reside in a user terminal. In another method, the processor and the storage medium may reside in the user terminal as an individual component.

The present technology may identify the caller who calls a vehicle.

The present technology may pay for the vehicle ride of a caller.

The present technology may improve caller convenience.

The present technology may improve the accessibility of vehicle calling by simplifying the card registration process.

The present technology may improve the accessibility of identification vehicle calling by simplifying the caller process and payment process.

The present technology may reduce the maintenance cost of a vehicle call service.

The present technology may improve service accessibility for the transportation disadvantaged.

In addition, various effects that are directly or indirectly understood through the present disclosure may be provided.

Although embodiments of the present disclosure have been described for illustrative purposes, those having ordinary skill in the art should appreciate that various modifications, additions and substitutions are possible, without departing from the scope and spirit of the disclosure.

Therefore, the embodiments disclosed in the present disclosure are provided for the sake of descriptions and are not intended to limit the technical concepts of the present disclosure. It should be understood that such embodiments are not intended to limit the scope of the technical concepts of the present disclosure. The protection scope of the present disclosure should be understood by the claims below, and all the technical concepts within the equivalent scopes should be interpreted to be within the scope of the present disclosure.

What is claimed is:

1. An electronic device comprising:
a memory configured to store at least one instruction; and
a processor configured to execute the at least one instruction,
wherein the processor is configured to execute the at least one instruction to:
obtain at least one of information about a caller calling a vehicle including the electronic device to a departure point, information about the departure point provided by the caller, or any combination thereof; and
register card information of a card corresponding to the information about the caller when the card information is not registered corresponding to the information about the caller, the card information being obtained based on a first card tagging of the caller who boards the vehicle at the departure point.

2. The electronic device of claim 1, wherein the processor is configured to execute the at least one instruction to pay for a vehicle boarding of the caller based on a second card tagging of the caller after registering the obtained card information corresponding to the information about the caller.

3. The electronic device of claim 1, wherein the processor is configured to execute the at least one instruction to:
determine whether the card information obtained based on a third card tagging matches the registered card information when the card information is registered corresponding to the information about the caller; and
pay for a vehicle boarding of the caller based on the third card tagging when the card information obtained based on the third card tagging matches the registered card information.

4. The electronic device of claim 1, wherein the processor is configured to execute the at least one instruction to provide guidance to the caller on how to call one of a plurality of vehicles including the vehicle, by identifying that the caller gets off the vehicle.

5. The electronic device of claim 2, wherein the processor is configured to execute the at least one instruction to:
provide a driver of the vehicle with at least one of the information about the caller, the information about the departure point, or any combination thereof, through an application for the driver of the vehicle;
provide the driver with guidance for performing the first card tagging;
provide the driver with guidance for determining whether to register the obtained card information corresponding to the information of the caller; and
provide the driver with guidance for performing the second card tagging.

6. The electronic device of claim 2, wherein the processor is configured to execute the at least one instruction to determine whether the caller is on board based on the second card tagging.

7. The electronic device of claim 1, further comprising:
a communication circuit,
wherein the processor is configured to execute the at least one instruction to obtain the card information by receiving the card information obtained based on the first card tagging from a card tagging device through the communication circuit.

8. The electronic device of claim 1, wherein the processor is configured to execute the at least one instruction to:
identify the card information based on an identification number of the card; and
identify the information about the caller based on the identification number of the caller.

9. The electronic device of claim 1, wherein the processor is configured to execute the at least one instruction to provide a driver of the vehicle with information about a caller whose card information is not registered among information about each of a plurality of callers when the plurality of callers exists.

10. The electronic device of claim 9, wherein the processor is configured to execute the at least one instruction to provide the driver with guidance for designating information about a caller to be registered corresponding to the card information obtained based on the first card tagging among the information about each of the plurality of callers when the plurality of callers exists according to information about a caller who is not registered corresponding to the card information.

11. A method performed by an electronic device, the method comprising:
obtaining at least one of information about a caller calling a vehicle including the electronic device to a departure point, information about the departure point provided by the caller, or any combination thereof; and
registering card information of a card corresponding to the information about the caller when the card information is not registered corresponding to the information about the caller, the card information being obtained based on a first card tagging of the caller who boards the vehicle at the departure point.

12. The method of claim 11, further comprising:
paying for a vehicle boarding of the caller based on a second card tagging of the caller after registering the obtained card information corresponding to the information about the caller.

13. The method of claim 11, further comprising:
determining whether the card information obtained based on a third card tagging matches the registered card information when the card information is registered corresponding to the information about the caller; and
paying for a vehicle boarding of the caller based on the third card tagging when the card information obtained based on the third card tagging matches the registered card information.

14. The method of claim 11, further comprising:
providing guidance to the caller on how to call one of a plurality of vehicles including the vehicle, by identifying that the caller gets off the vehicle.

15. The method of claim 12, further comprising:
providing a driver of the vehicle with at least one of the information about the caller, the information about the departure point, or any combination thereof, through an application for the driver of the vehicle;
providing the driver with guidance for performing the first card tagging;
providing the driver with guidance for determining whether to register the obtained card information corresponding to the information of the caller; and
providing the driver with guidance for performing the second card tagging.

16. The method of claim 12, further comprising:
determining whether the caller is on board based on the second card tagging.

17. The method of claim 11, wherein registering the card information includes obtaining the card information by receiving the card information obtained based on the first card tagging from a card tagging device through a communication circuit.

18. The method of claim 11, wherein the card information includes an identification number of the card, and
wherein the information about the caller includes an identification number of the caller.

19. The method of claim 11, further comprising:
providing a driver of the vehicle with information about a caller whose card information is not registered among information about each of a plurality of callers when the plurality of callers exists.

20. The method of claim 19, further comprising:
providing the driver with guidance for designating information about a caller to be registered corresponding to the card information obtained based on the first card tagging among the information about each of the plurality of callers when the plurality of callers exists according to information about a caller who is not registered corresponding to the card information.
